(19) United States
(12) Patent Application Publication
(10) Pub. No.: US 2014/0082280 A1
(43) Pub. Date: Mar. 20, 2014

(54) STORAGE APPARATUS AND CONTROL METHOD

(71) Applicant: FUJITSU LIMITED, Kawasaki-shi (JP)

(72) Inventors: Katsuhiko Shioya, Yokohama (JP); Yasuhiro Onda, Kawasaki (JP); Suijin Taketa, Kawasaki (JP)

(73) Assignee: FUJITSU LIMITED, Kawasaki-shi (JP)

(21) Appl. No.: 13/944,936

(22) Filed: Jul. 18, 2013

(30) Foreign Application Priority Data
Sep. 18, 2012 (JP) 2012-204851

(51) Int. Cl. G06F 3/06

(52) U.S. Cl. CPC G06F 3/0689; G06F 3/0646; G06F 3/0619
USPC 711/114

(57) ABSTRACT

A storage apparatus is disclosed, including a first storage area, a second storage area, and a controller. The controller writes data to the first storage area based on a write request. When the data are written in the first storage area, the controller sequentially writes the data to the second storage area from a beginning of a physical address thereof. The controller outputs the data to a backup apparatus by sequentially reading out the data being written in the second storage area from the beginning of the physical address.

### CROSS-REFERENCE TO RELATED APPLICATIONS

This patent application is based upon and claims the benefit of priority of the prior Japanese Patent Application No. 2012-204851 filed on Sep. 18, 2012, the entire contents of which are incorporated herein by reference.

### FIELD

The embodiment discussed herein is related to a storage apparatus and a control method of the storage apparatus.

### BACKGROUND

A storage apparatus including a backup function has been known. Related to the storage apparatus, a data storage management system, which includes a second cumulatively storing part for cumulatively storing data files transferred from multiple file servers, and a part for automatically managing transmission of the data files between the multiple file servers and the second cumulatively storing part. In the data storage management system, when the data file is transferred from the storage server to store, the data file is enclosed in a large data block which is called a “transmission unit”. The transmission unit is backed up to another backup medium such as a high density electromagnetic tape through a backup drive apparatus.

### PATENT DOCUMENTS

Japanese Laid-open Patent Publication No. 09-510806

### SUMMARY

According to one aspect of the embodiment, there is provided a storage apparatus, including a first storage area; a second storage area; and a controller configured to write data to the first storage area based on a write request, sequentially write the data to the second storage area from a beginning of a physical address thereof when the data are written in the first storage area, and output the data to a backup apparatus by sequentially reading out the data being written in the second storage area from the beginning of the physical address.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a diagram illustrating a configuration example of a storage system including a storage apparatus:

FIG. 2 is a diagram schematically illustrating functions and process contents of the storage apparatus;

FIG. 3 illustrates an example of a sequence diagram depicting a flow of a process performed by the storage system in a case of successively conducting processes (1) through (10);

FIG. 4 is a diagram schematically illustrating process contents of the storage apparatus in a case in which a host sends the backup request to the storage apparatus at a desired timing;

FIG. 5 is a diagram illustrating an example of a data structure stored in a backup area;

FIG. 6 is a diagram illustrating an example of a hierarchical structure of a file system in the storage apparatus;

FIG. 7 is a diagram illustrating an example of a brief write process flow in the storage apparatus;

FIG. 8 is a sequence diagram illustrating a flow of a process which may be conducted in a storage apparatus in a comparison;

FIG. 9 illustrates a data structure example of a backup management table; and

FIG. 10 is a diagram illustrating an example of header information.

### DESCRIPTION OF EMBODIMENTS

In the following, embodiments of the present invention will be described with reference to the accompanying drawings.

In a storage apparatus, a sequential write is performed when writing data with respect to a state immediately after an operation start. Write and delete operations are repeated, and an area becomes segmented. Thus, a random access is mainly conducted.

Also, as a storage device in the storage apparatus, a HDD (Hard Disk Drive) or the like is mainly used. Especially, if the backup is attempted in the storage apparatus using the storage device such as the HDD or the like, positioning in the storage device, or positioning in a backup device such as a LTO (Linear Tape-Open) or the like is performed. Especially, in a case of handling data having relatively small size consisting of dozens to hundreds of kilobytes, meta information is frequently accessed with respect to a disk, and reading out of data occurs with a shorter I/O (Input/Output) length, when an I/O request is occurred. Hence, a throughput performance of reading data is reduced. In the environment, it is difficult to utilize performance of the backup device in a case in which the file is backed up to a sequential access device such as the LTO or the like. As a result, even if the storage apparatus is provided with a RAID (Redundant Arrays of Inexpensive Disks) mechanism, the LTO, and the like each having sufficient performance, wheres performance as a whole may not be sufficiently demonstrated.

Regarding this point, in the backup drive apparatus, re-arrangement of the data files is conducted among layers while retaining a directory structure. Thus, it is difficult to sufficiently suppress reduction of the process speed due to the positioning.

Accordingly, as one aspect of an embodiment, there is provided a storage apparatus which is capable of reducing the process time for the backup.

### Embodiment

In the following, examples of a storage apparatus, a control method of the storage apparatus, and a control program of the storage apparatus will be described with reference to the accompanying drawings.

### [Configuration]

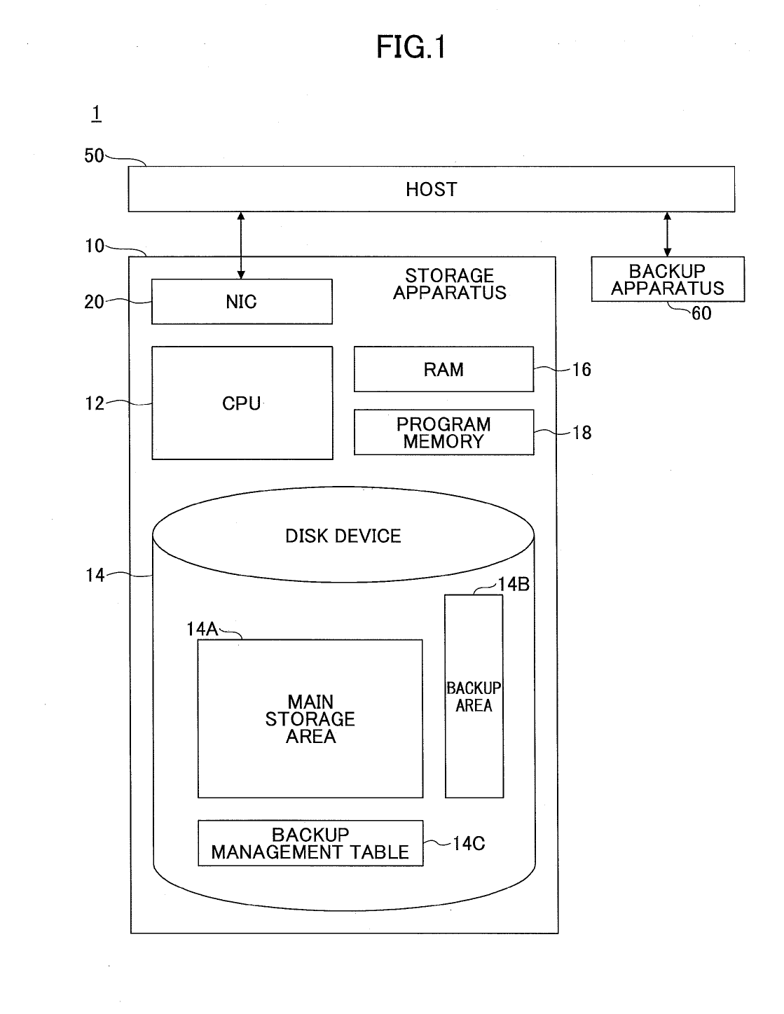

FIG. 1 is a diagram illustrating a configuration example of a storage system 1 including a storage apparatus 10. The storage apparatus 10 may be a Network Attached Storage (NAS) apparatus connected to a backup apparatus 60 through a host 50. The NAS apparatus corresponds to a file server dedicated apparatus which is directly connected to a network, and may be used by directly connecting via a Transmission Control Protocol/Internet Protocol (TCP/IP) network. The backup apparatus 60 may be a tape device. The backup apparatus 60 may be an HDD or other storage device.

The storage apparatus 10 includes a Central Processing Unit (CPU) 12, a disk device 14, a Random Access Memory (RAM) 16, a program memory 18, and a Network Interface Card (NIC) 20.

The CPU 12 executes a program stored in the program memory 18. The program memory 18 may be a disk device other than the disk device 14. The program memory 18 may correspond to a dedicated area for the disk device 14. Alternatively, the program memory 18 may be a Read-Only Memory (ROM), an Electrically Erasable and Programmable Read-Only Memory (EEPROM), a Solid State Drive (SSD), or the like.

The disk device 14 may be a HDD, a DVD (Digital Versatile Disc), a Blu-ray (trademark) disk, or the like. In the disk device 14, a main storage area 14A and a backup area 14B are set. The main storage area 14A is an area to which data are written in response to a write request from the host 50. The backup area 14B is an area used as an intermediate area when data are transferred to the backup apparatus 60. The backup area 14B may be set in the RAM 16, instead of the disk device 14. Alternatively, the backup area 14B may be set in another storage device such as the SSD, the EEPROM, or the like.

The RAM 16 may be used to develop a program stored in the program memory 18 and may be used as a cache with respect to the disk device 14.

The NIC 20 conducts communications with the host 50.

### [Process Contents]

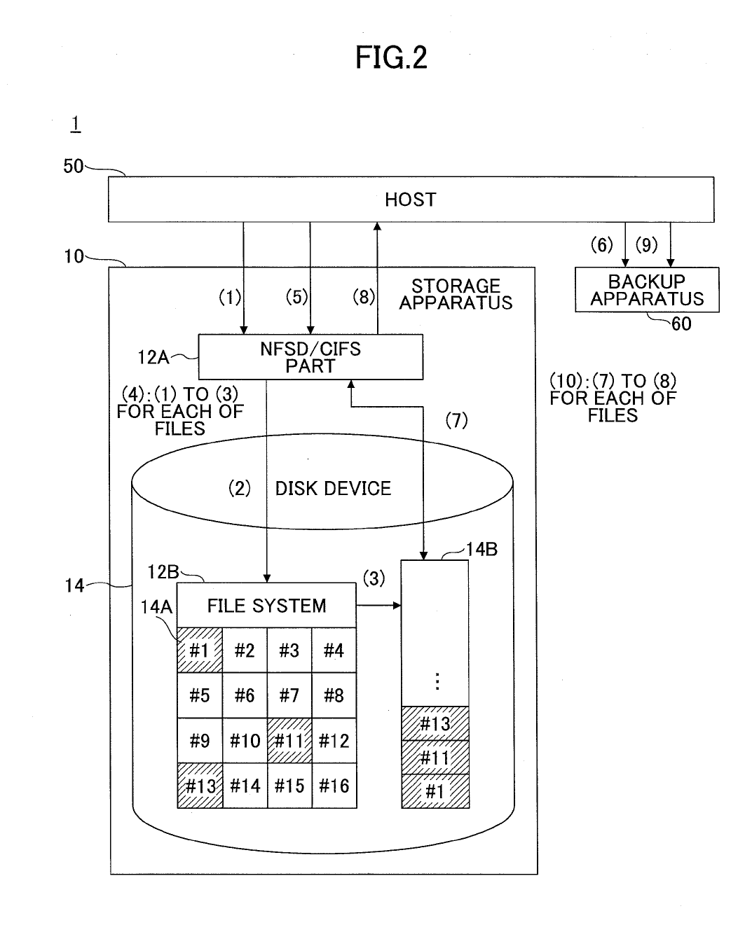

FIG. 2 is a diagram schematically illustrating functions and process contents of the storage apparatus 10. The host 50 accesses the main storage area 14A through a Network File System Daemon (NFSD) for a LINUX (trademark) type client or a Common Internet File System (CIFS) for a Windows (trademark) type client. The NFSD and the CIFS are regarded as software for protocol analysis and file access based on a file access method in LINUX and Windows, respectively. In FIG. 2, functional parts, which are realized by executing the NFSD and the CIFS, are denoted by an NFSD/CIFS part 12A.

The NFSD/CIFS part 12A writes data in the main storage area 14A based on a write request received from the host 50. Also, the NFSD/CIFS part 12A reads the data from the main storage area 14A and outputs the data to the host 50 in response to a read request received from the host 50.

Also, the NFSD/CIFS part 12A sequentially writes data from a beginning of a physical address of the backup area 14B when writing the data to the backup area 14B. Then, when a backup request is received from the host 50, the NFSD/CIFS part 12A sequentially reads out the data, which are written in the backup area 14B, from the beginning of the physical address, and outputs the data to the backup apparatus 60 through the host 50. Accordingly, the backup area 14B is controlled by a First-In-First-Out (FIFO).

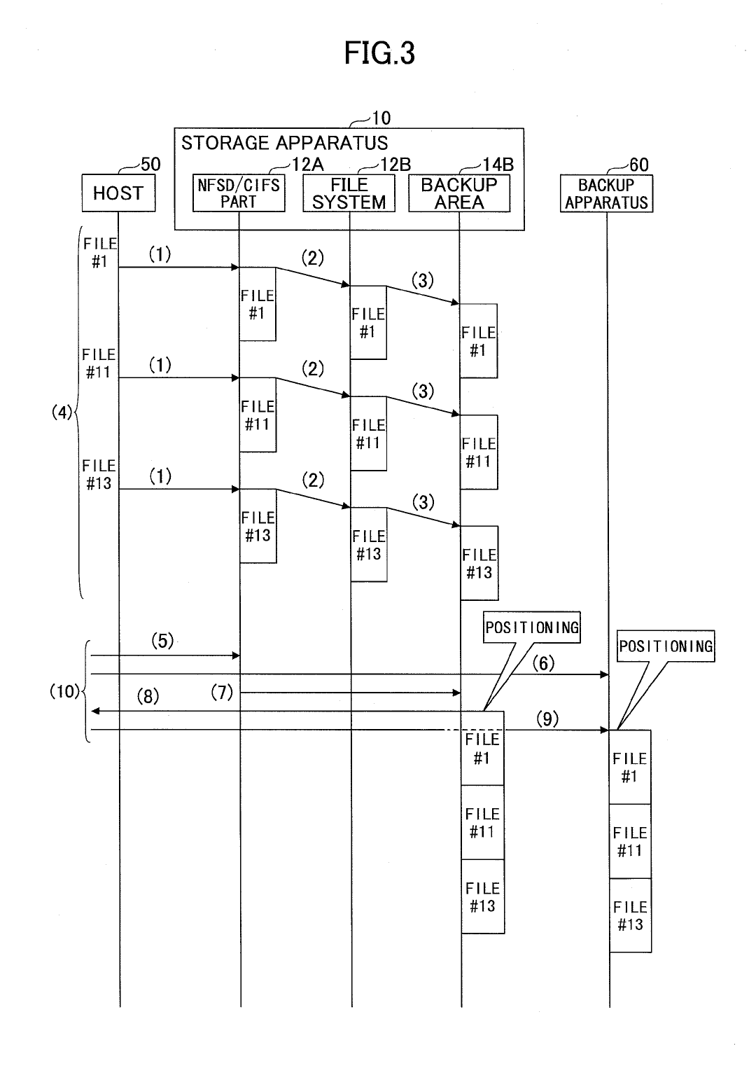

Numerals 1-10 in ( ) in FIG. 2 denote processes for each stage in the storage system 1. Also, FIG. 3 illustrates an example of a sequence diagram depicting a flow of a process performed by the storage system 1 in a case of successively conducting the processes (1) through (10).

(1) First, the host 50 sends the write request of a file to be a backup target with respect to the storage apparatus 10. In this case, the write requests pertinent to files #1, #11, and #13 are conducted by the host 50.

(2) the NFSD/CIFS part 12A receives each of the write requests from the host 50, and controls a file system 12B, so as to conduct positioning of a disk towards a location for the file #1 in the main storage area 14A. Then, the NFSD/CIFS part 12A writes the file #1. In detail, the NFSD/CIFS part 12A issues a write command with respect to the disk device 14 storing the file #1, to the file system 12B. In a process of the write command by the file system 12B, a positioning operation of a head of the disk device 14 and an actual data write are conducted. Details of the file system 12B will be described later.

(3) When writing of one file requested by the host 50 is completed (or in parallel with the writing of one file), the NFSD/CIFS part 12A sequentially writes the same file from the beginning of the physical address of the backup area 14B. For this writing, a command prepared by the file system 12B is used.

(4) The NFSD/CIFS part 12A repeats the above processes (2) and (3) for each of the files #1, #11, and #13 to which the write requests are received from the host 50. In FIG. 2, hatched areas in the main storage area 14A indicate updated areas in response to the write requests received from the host 50. Since the writing of the file is repeated in the main storage area 14A, it is assumed that areas updated in response to the write requests are dispersed. On the other hand, in the backup area 14B, regardless of a storage area in the main storage area 14A, the files #1, #11, and #13, which are updated in response to the write requests in the main storage area 14A, are stored in a write order from the beginning of the physical address of the backup area 14B. In FIG. 2, a bottom end of the backup area 14B corresponds to the beginning of the physical address.

(5) After that, the host 50 sends the backup request to the storage apparatus 10.

(6) Also, the host 50 sends the backup request to the backup apparatus 60. The backup apparatus 60 performs a positioning towards a location to store the file #1, and conducts a write preparation for the file #1.

(7) The NFSD/CIFS part 12A receives the backup request from the host 50, and outputs a read instruction with respect to the backup area 14B.

(8) After that, the NFSD/CIFS part 12A controls the NIC 20 and sends the file #1 to the host 50.

(9) When the host 50 receives the file #1 to back up, the host 50 transfers the file #1 to the backup apparatus 60 and requests the writing of the file #1.

(10) The host 50 repeats the above processes (7) through (9) until the end of the backup area 14B, and completes the backup process. When the storage apparatus 10 completes one backup process, the storage apparatus 10 deletes contents in the backup area 14B. When a next write to the main storage area 14A occurs, the storage apparatus 10 writes a file from the beginning of the physical address of the backup area 14B.

In this case, the host 50 does not always conduct the write request and the backup request as a series of processes. The host 50 may send the backup request at a desired timing to the storage apparatus 10. When a free area of the backup area 14B becomes lower than a threshold (for example, a small percentage of the entire area), the host 50 sends the backup request to the storage apparatus 10. In this case, the storage apparatus 10 may periodically send the free area size of the backup area 14B to the host 50. The host 50 may count the number of files cumulatively stored in the backup area 14B. This control may be conducted in response to an input operation of a user with respect to the host 50, or may be voluntarily conducted by the storage apparatus 10.

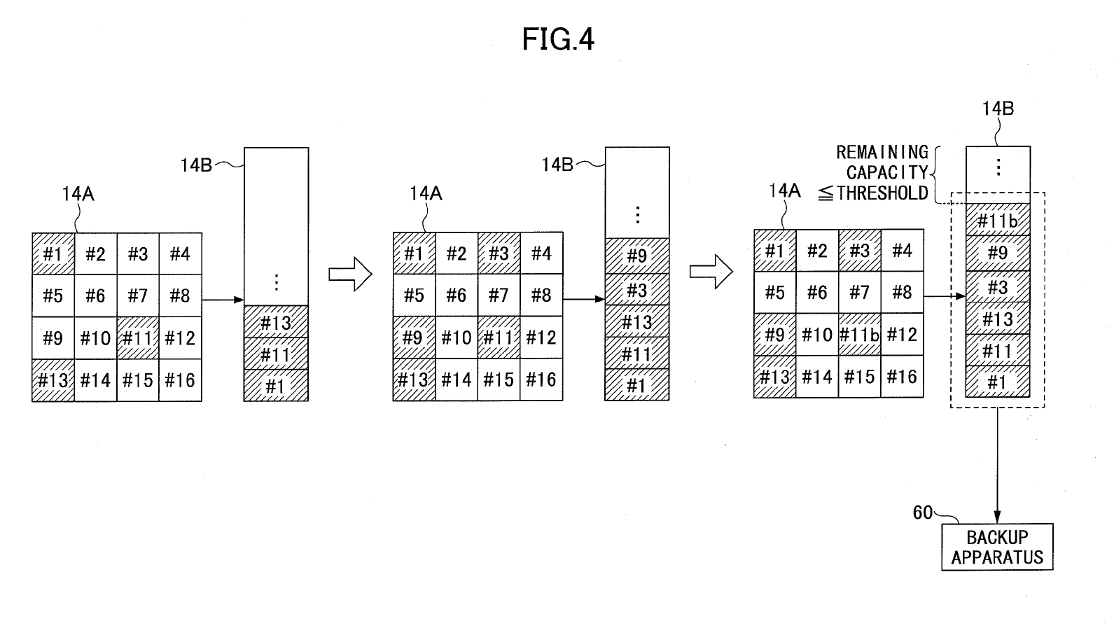

FIG. 4 is a diagram schematically illustrating process contents of the storage apparatus 10 in a case in which the host 50 sends the backup request to the storage apparatus 10 at a desired timing. In an example illustrated in FIG. 4, first, the write requests are made for the files #1, #11, and #13, the write requests are made for the files #3 and #9, and then, the write request are made to update the file #11 with a file #11b. In this case, the files #1, #11, #13, #3, #9, and #11b are written in order of mention in the backup area 14B. If the free area size of the backup area 14B becomes lower than the threshold at a time the file #11b is written to the backup area 14B, the host 50 sends the backup request to the storage apparatus 10. The storage apparatus 10 reads and sends the files #1, #11, #13, #3, #9, and #11b in order of mention to the host 50 to transfer these files to the backup apparatus 60.

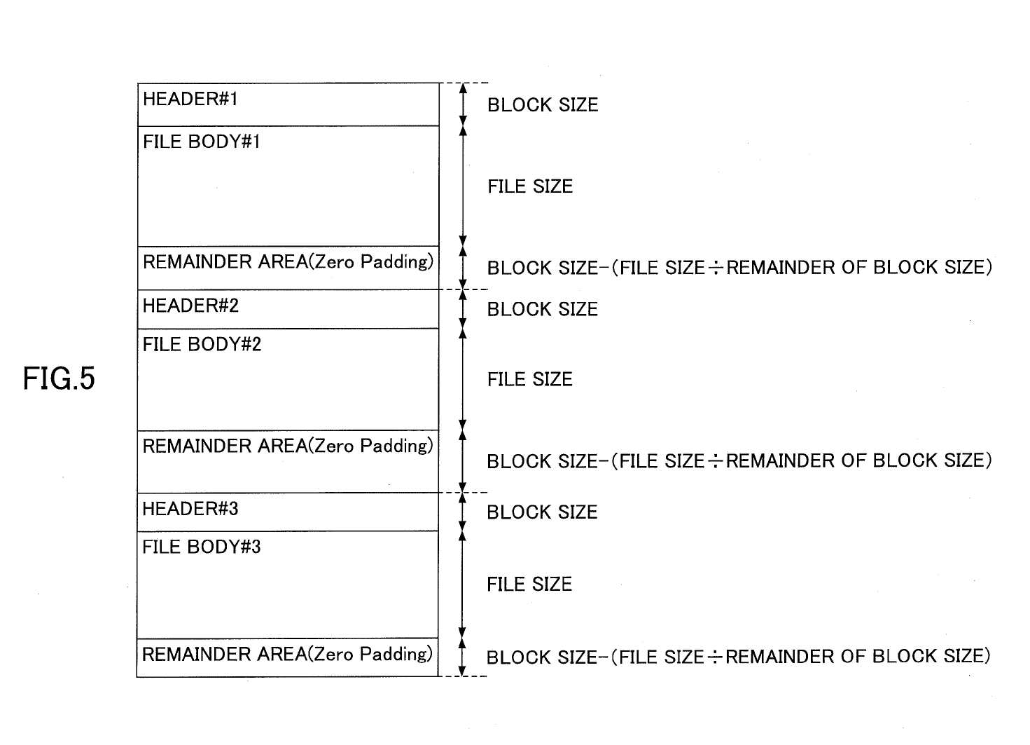

FIG. 5 is a diagram illustrating an example of a data structure stored in the backup area 14B. Data stored in the backup area 14B may be accordance with a Tape ARchive format (TAR). In the backup area 14B, a single file is stored in an area corresponding to an integral multiple of a certain block size. The area to store the single file includes a header, a file body, and a remainder area (Zero padding). The header may be generated as data having just a size to be accommodated in a block size. The remainder area has a size acquired by deducting a remainder from the block size. The remainder results from dividing the size of the file body with the block size. The block size may be consistent with a write length to the backup apparatus 60. The block size may be a size for sufficiently drawing out a sequential access performance of the backup apparatus 60. Also, the entire length of the backup area 14B is preferably tunable to correspond to restrictions of a format or a backup medium.

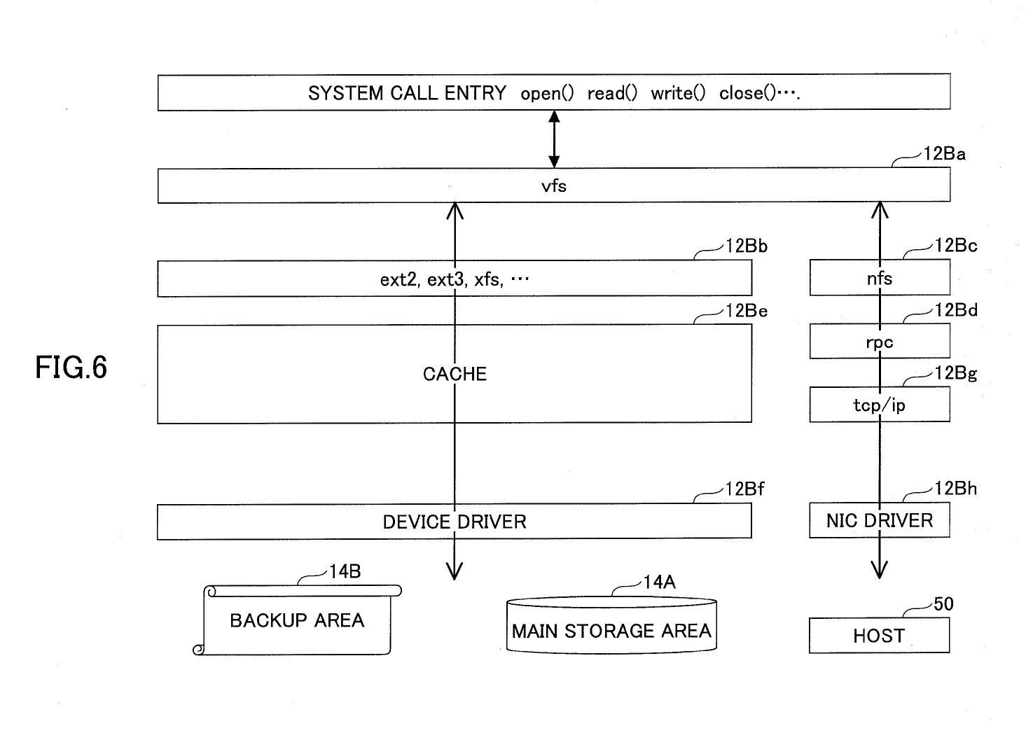

FIG. 6 is a diagram illustrating an example of a hierarchical structure of the file system 12B in the storage apparatus 10. In a case in which the file system 12B is formed on the basis of Linux, the file system 12B may include software of respective file systems 12Ba and 12Bb such as vfs, ext2, ext3, xfs, and the like, an nfs 12Bc, an rpc (Remote Procedure Call) 12Bd, and the like. The file system 12Bb accesses a cache 12Be in the RAM 16, and further accesses the disk device 14 through a device driver 12Bf. The cache 12Be includes a page cache and a buffer cache which are implemented in an Operating System (OS). The device driver 12Bf is software for controlling the disk device 14.

Also, the vfs 12Ba communicates with the host 50 through the nfs 12Bc, the rpc 12Bd which regulates a procedure between different machines in a common network, a tcp/ip 12Bg corresponding to a network layer, and an NIC driver 12Bh. The nfs 12Bc is regarded as a layer corresponding to the file system 12Bb.

In the file system 12B having the above described hierarchical structure, I/O requests (the write request and the read request) from the host 50 to the disk device 14 are controlled in accordance with the following routes:

NIC driver 12Bh→tcp/ip 12Bg→rpc 12Bd→nfs 12Bc→vfs 12Ba→file system 12Bb→cache 12Be→device driver 12Bf→disk device 14.

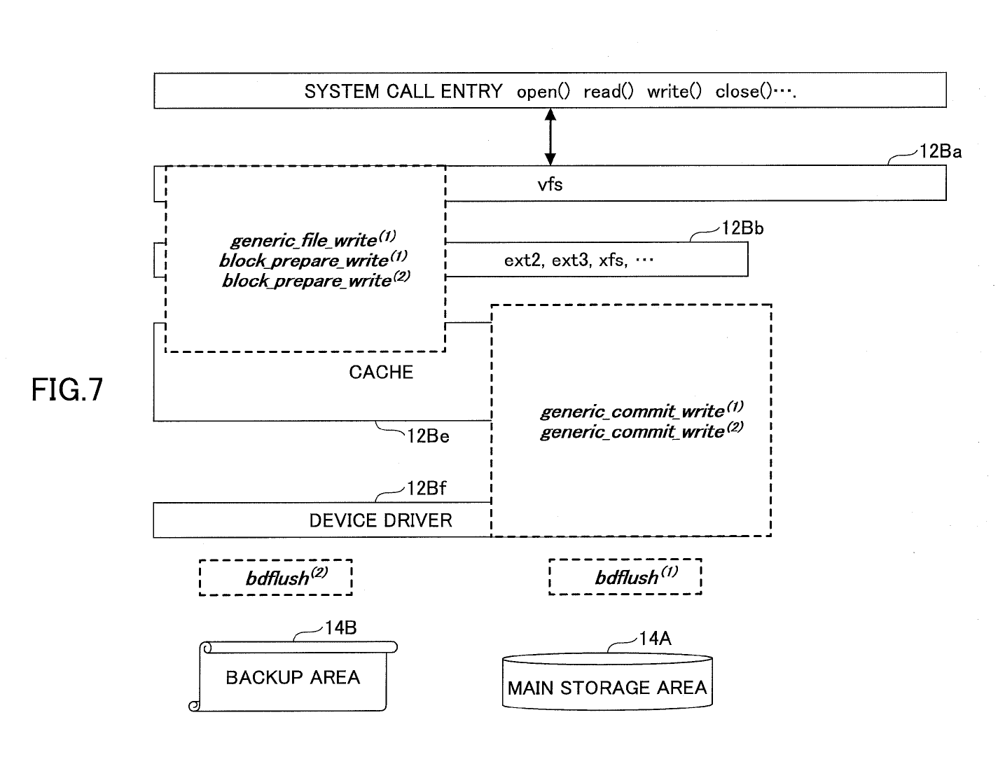

FIG. 7 is a diagram illustrating an example of a brief write process flow in the storage apparatus 10. A write operation to the main storage area 14A may be executed in the following procedures.

(a) generic_file_write⁽¹⁾

The generic_file_write⁽¹⁾ corresponds to a general procedure for a write access to a file in a file system, and is called from the vfs 12Ba when a write of the file is conducted. When the generic_file_write⁽¹⁾ is executed, write data received from the vfs 12Ba are written in the page cache of an indicated file, and a state is changed to a Dirty state. In an execution process of the generic_file_write⁽¹⁾, a write to the page cache alone is conducted, and a write to the disk device 14 is delayed.

(b) block_prepare_write⁽¹⁾

The block_prepare_write⁽¹⁾ conducts a prepare_write process specific to the file system. The block_prepare_write⁽¹⁾ allocates a buffer and allocates a disk block, for the page cache of a write subject.

(c) generic_commit_write⁽¹⁾

The generic_commit_write⁽¹⁾ sets the Dirty state to the buffer cache corresponding to a write area. Also, the Dirty state is set to a respective page cache. Later, update data in the page cache is written in a disk.

(d) bdflush⁽¹⁾

The bdflush⁽¹⁾ writes dirty data in the cache to the disk device 14.

In the page cache, the data of the write subject remains. The write to the backup area 14b may be executed in accordance with the following procedures:

(a) block_prepare_write⁽²⁾

The block_prepare_write⁽²⁾ temporarily converts data cached in a page into a buffer format (a data format for a disk write). Also, the block_prepare_write⁽²⁾ indicates a write start address in the backup area 14B.

(b) generic_commit_write⁽²⁾

The generic_commit_write⁽²⁾ conducts a process similar to the generic_commit_write⁽¹⁾.

(c) bdflush⁽²⁾

The bdflush⁽²⁾ writes the dirty data in the cache to the disk device 14. By this operation, the file is actually written in the backup area 14B.

[Comparison with Another Storage Apparatus]

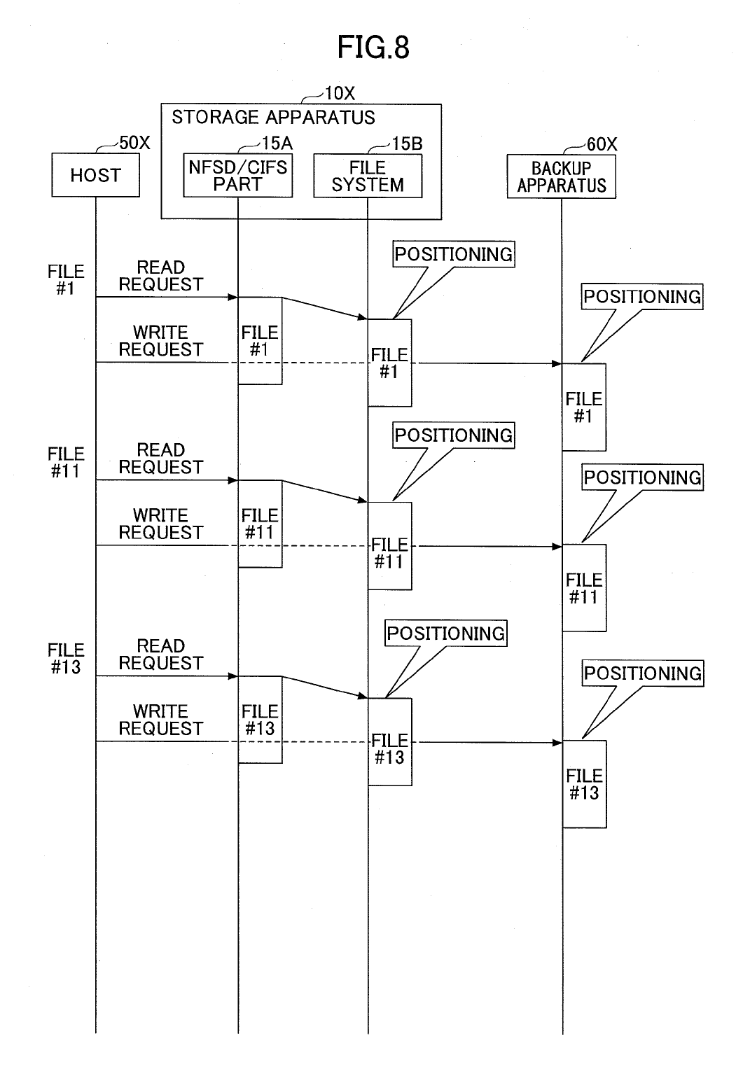

A comparison with another storage apparatus (called a “storage apparatus 10X”), which does not includes the backup area 14B according to the embodiment, will be described. FIG. 8 is a sequence diagram illustrating a flow of a process which may be conducted in the storage apparatus 10X. The storage apparatus 10X includes an NFSD/CIFS part 15A and a file system 15B. FIG. 8 illustrates the process in a case in which the backup requests of the files #1, #11, and #13 are sent from a host 50X to the storage apparatus 10X. In this case, the host 50X may send a request to the storage apparatus 10X and backup apparatus 60X.
(a) The read request of the file #1 to the storage apparatus 10X→the write request of the file #1 to the backup apparatus 60X.
(b) The read request of the file #11 to the storage apparatus 10X→the write request of the file #11 to the backup apparatus 60X.
(c) The read request of the file #13 to the storage apparatus 10X→the write request of the file #13 to the backup apparatus 60X.

In the above described processes, each of the positioning in a disk device in the storage apparatus 10X and the positioning in the backup apparatus 60X occurs three times. As previously described, since the writing of the file is repeated in the disk device, it is assumed that areas updated in response to the write requests are dispersed.

On the other hand, as described in FIG. 3, in the storage apparatus 10 according to the embodiment, the positioning is performed in response to the backup request only once for each of the disk device 14 and the backup apparatus 60. As a result, it is possible to reduce a process time for the backup more than the storage apparatus 10X. As illustrated in FIG. 3, the positioning occurs for each of files when the files are written in the disk device 14. This write operation is conducted similarly in the storage apparatus 10X.

### [Others]

In the storage apparatus 10 in the embodiment, it is possible to reduce a process speed for the backup as described above. However, a file arrangement in the main storage area 14A is different from that in the backup apparatus 60. Thus, when a desired file is restored at a desired time for data stored in chronological order into the backup apparatus 60, the desired file is searched for from the beginning of a medium (hereinafter, simply called “tape”) of the backup apparatus 60. Then, the file is read out. Accordingly, if a location of a subject file is not ascertained beforehand, a search of the file may take a relatively long time.

By implementing the following functions, the file search of the tape may be effectively conducted.

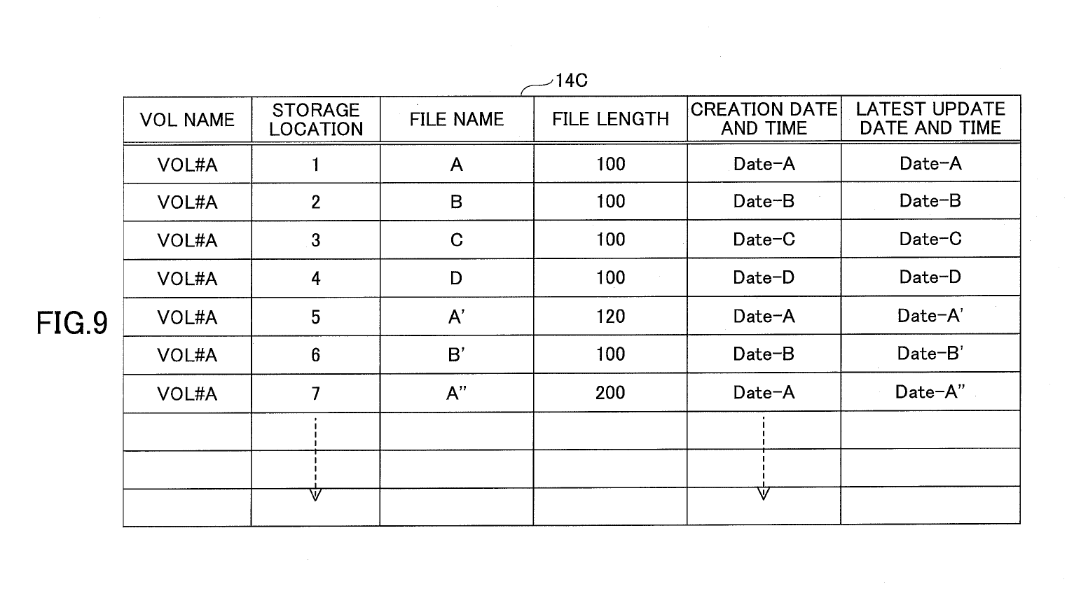

The storage apparatus 10 includes a backup management table 14C for storing a storage location which indicates a count of storage locations of the files from the beginning of the tape when the file is stored on the tape. FIG. 9 illustrates a data structure example of the backup management table 14C. The backup management table 14C may include a volume name, the storage location on the tape, a file name, a file length, a creation date, a latest update date and time, and the like. In the backup management table 14C, when the same file is updated, information is additionally recorded at an end of a list.

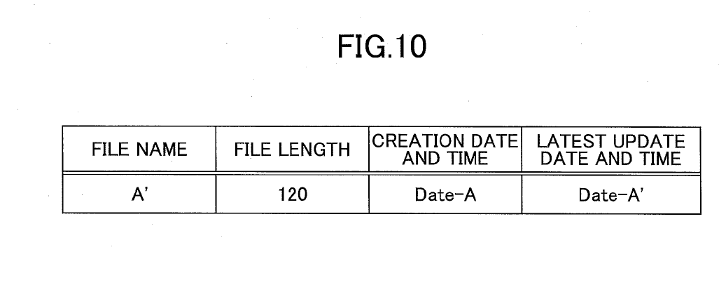

On the other hand, when the file is stored to the tape, header information is provided at a beginning of each of the files. The header information may include the file name, the file length, the creation date, the latest update date and time. FIG. 10 is a diagram illustrating an example of the header information.

In a case of conducting a restore, the header information of a file of a restore subject is searched for as a search condition in the backup management table 14C. A location of the file of the restore subject on the tape is determined based on matched table information. The restore is performed from the tape. By these operations, it is possible to omit reading information of a file body on the tape when the restore is performed from the tape. Hence, it is possible to read the file of the restore subject by simply searching for the storage location of the file at an earlier stage and positioning at the storage location of the file on the tape.

Also, when the storage apparatus 10 is defective, the following processes may be performed.

(1) In a case in which a process is interrupted for some reason when the write operation is conducted to the backup area 14B, the write process is performed again by using original data to which the writing to the main storage area 14A is completed. Especially in case of a power outage, it is preferable that a battery or the like is mounted in the storage apparatus 10, and it is preferable to take measures so as to assure a data write time.

(2) In a case of a failure of the backup area 14B itself, it is possible to avoid an error by creating and retaining a copy of data in a different location in the backup area 14B.

(3) In a case in which an error is detected at the backup apparatus 60 when the file is transferred from the backup area 14B to the backup apparatus 60, similar to a common tape backup mechanism, the file to which the error is detected is transferred again to the backup apparatus 60.

(4) In a case in which an error is detected at the backup apparatus 60 when data are restored by using backup data of the backup apparatus 60, similar to a restore process from a common tape, the file to which the error is detected is read out again from the backup apparatus 60.

According to the storage apparatus 10, the control method of the storage apparatus 10, and the control program of the storage apparatus 10, it is possible to reduce the process time for the backup.

The main storage area 14A may be an example of a “first storage area”, the backup area 14B may be an example of a “second storage area”, and a storage area for the backup management table 14C may be an example of a “third storage area”. Also, the NFSD/CIFS part 12A may be an example of a “controller”.

According to the embodiment, in the storage apparatus 10, it is possible to reduce the process time for the backup.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage apparatus, comprising:
a first storage area;
a second storage area; and
a controller configured to
write data to the first storage area based on a write request,
sequentially write the data to the second storage area from a beginning of a physical address thereof when the data are written in the first storage area, and
output the data to a backup apparatus by sequentially reading out the data being written in the second storage area from the beginning of the physical address.

2. The storage apparatus according to claim 1, wherein the controller deletes the data from the second storage area when the data written in the second storage area are output.

3. The storage apparatus according to claim 1, wherein the controller stores location information capable of specifying a storage location in the backup apparatus in a third storage area, and provides information for matching with the location information stored in the third storage area in the data to be output to the backup apparatus, when the data written in the second storage area are sequentially read out from the beginning of the physical address and are output to the backup apparatus; and
the controller recognizes a storage location of subject data to restore in the backup apparatus by using the location information stored in the third storage area when restoring the data by using the backup apparatus.

4. The storage apparatus according to claim 1, wherein the first storage area is in a disk device.

5. The storage apparatus according to a claim 1, wherein the first storage area is an area in a cache with respect to a disk device.

6. A control method executed by a computer, the control method comprising:
writing data to a first storage area based on a write request;
sequentially write the data to a second storage area from a beginning of a physical address thereof when the data are written in the first storage area; and
outputting the data to a backup apparatus by sequentially reading out the data being written in the second storage area from the beginning of the physical address.

7. The control method according to claim 6, wherein when the data written in the second storage area are output, the computer deletes the data from the second storage area.

8. The control method according to claim 6, wherein:
when sequentially reading out the data written to the second storage area from the beginning of the physical address and outputting the data to the backup apparatus, the computer
stores location information capable of specifying a storage location in the backup apparatus to a third storage area; and
provides information for matching with the location information stored in the third storage area in the data to be output to the backup apparatus, and
when restoring the data by using the backup apparatus, the computer recognizes a storage location of subject data to restore in the backup apparatus by using the location information stored in the third storage area.

9. A computer-readable recording medium recorded with a program having a computer execute a control process comprising:
writing data to a first storage area based on a write request;
sequentially write the data to a second storage area from a beginning of a physical address thereof when the data are written in the first storage area; and
outputting the data to a backup apparatus by sequentially reading out the data being written in the second storage area from the beginning of the physical address.

10. The computer-readable recording medium according to claim 9, wherein the control process further comprises deleting the data from the second storage area when the data written in the second storage area are output.

11. The computer-readable recording medium according to a claim 9, wherein the control process further comprises:
storing location information capable of specifying a storage location in the backup apparatus to a third storage area, and providing information for matching with the location information stored in the third storage area in the data to be output to the backup apparatus, when the data written to the second storage area sequentially read out from the beginning of the physical address and outputs the data to the backup apparatus; and
recognizing a storage location of subject data to restore in the backup apparatus by using the location information stored in the third storage area, when the data are restored by using the backup apparatus.
